(19) United States
(12) Patent Application Publication
(10) Pub. No.: US 2006/0039247 A1
(43) Pub. Date: Feb. 23, 2006

(54) Method for adjusting deviation on seeking BCA in optical disk

(75) Inventor: Jee-hyung Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/202,031

(22) Filed: Aug. 12, 2005

(30) Foreign Application Priority Data
Aug. 17, 2004 (KR) 10-2004-0064504

(51) Int. Cl. G11B 7/085

(52) U.S. Cl. 369/30.03

(57) ABSTRACT

A method for adjusting a deviation occurring on seeking a burst cutting area (BCA) in an optical disc, including, when an optical disc is loaded into an optical reproducing apparatus, reading data from a predetermined position of the BCA, reading data from the predetermined position of the BCA and first and second points at predetermined distances from left and right sides of the predetermined position of the BCA, processing the read data to determine whether the read data corresponds to BCA data, and if the data read from all of the predetermined position of the BCA and the first and second points corresponds to the BCA data, determining the predetermined position of the BCA as a final position of the BCA in which a deviation has been adjusted and storing information as to the final position of the BCA as information to seek the burst cutting area in a memory of the optical reproducing apparatus.

### CROSS-REFERENCE TO RELATED APPLICATION

This application claims the benefit of Korean Patent Application No. 2004-64504 filed Aug. 17, 2004, in the Korean Intellectual Property Office, the disclosure of which is incorporated herein by reference.

### BACKGROUND OF THE INVENTION

1. Field of the Invention

The present invention relates to an optical reproducing apparatus, and more particularly, to a method for adjusting a deviation on seeking a bust cutting area (BCA) in an optical disc using an optical reproducing apparatus.

2. Description of the Related Art

Optical reproducing apparatuses such as digital versatile disc player (DVDP) reproduce data from various types of optical discs such as DVD and compact disc (CD) along tracks formed on the surfaces of the optical discs.

With the current widespread use of optical discs, data is illegally copied from the optical discs. Also, general users can easily copy the data from the optical discs. As a result, various techniques have been developed to prevent the data copy so as to protect copyright holders from infringement of the copyright.

As one of the various techniques for preventing the data from being copied from the optical discs, there is a method of recording copy protection information using a burst cutting area (BCA). A BCA is cut with a laser by a manufacturer after a process of manufacturing an optical disc is completed. The BCA is positioned in an inner circumference of the optical disc and includes a serial number of the optical disc, copy protection information, and the like.

Information recorded in a BCA must be reproduced to reproduce data recorded on an optical disc having the BCA. However, unlike a general data area formed along an outer track of the optical disc, the BCA is formed in the form of a circular belt in the vicinity of an inner rotation drive hole of the optical disc. Thus, in order to seek the BCA, a pickup must be moved to a predetermined position to read BCA data from the optical disc by maintaining only focusing without maintaining tracking.

Accordingly, when an optical reproducing apparatus uses a stepping motor, the optical reproducing apparatus moves the pickup by the preset number of steps according to the stepping motor. When the optical reproducing apparatus uses a direct current (DC) motor, the optical reproducing apparatus moves the pickup to a predicted position of the BCA according to the level of a track driving (TRD) signal for controlling the DC motor.

However, the above-described method of moving the pickup by the preset number of operations or to the predicted position of the BCA using the TRD signal is equally applied to mass produced optical reproducing apparatuses. Thus, the position to which the pickup substantially moves may vary with an instrumental position deviation of each apparatus and a performance deviation of a motor. Thus, the optical reproducing apparatus may not rapidly seek the BCA and thus may not immediately reproduce data from the BCA.

Also, in a case that the BCA data is not be read from the position to which the pickup has been moved, the optical reproducing apparatus arbitrarily moves the pickup to search the optical disc so as to seek the BCA until the BCA data is read. However, in this case, the time required to seek the BCA is elongated, thereby requiring a large amount of time to reproduce data from the optical disc. Accordingly, a method of further rapidly and exactly seeking a BCA of an optical disc is required.

### SUMMARY OF THE INVENTION

Additional aspects and/or advantages of the invention will be set forth in part in the description which follows and, in part, will be apparent from the description, or may be learned by practice of the invention.

Accordingly, the present general inventive concept has been made to solve the above-mentioned and/or problems, and an aspect of the present general inventive concept is to provide a method for adjusting a deviation occurring on seeking a BCA in an optical disc using an optical reproducing apparatus so as to reduce a time required for reproducing data from the optical disc.

According to an aspect of the present invention, there is provided a method for adjusting a deviation occurring on seeking a burst cutting area in an optical disc, including when an optical disc is loaded into an optical reproducing apparatus, reading data from a predetermined position of the burst cutting area; reading data from the predetermined position of the burst cutting area and first and second points at predetermined distances from left and right sides of the predetermined position of the burst cutting area; processing the read data to determine whether the read data corresponds to burst cutting area data; and if the data read from all of the predetermined position of the burst cutting area and the first and second points correspond to the burst cutting area data, determining the predetermined position of the burst cutting area as a final position of the burst cutting area in which a deviation has been adjusted and storing information as to the final position of the burst cutting area as information to seek the burst cutting area in a memory of the optical reproducing apparatus.

The method may further comprise if the data read from all of the predetermined position of the burst cutting area and the first and second points does not correspond to the burst cutting area, reading data from a third point at a predetermined distance from the first point in an opposite direction to a direction of the second point from the predetermined position of the burst cutting area.

The method may further comprise processing the data read from the third point to determine whether the data read from the third point corresponds to the burst cutting area data; and if the data read from the third point does not correspond to the burst cutting area data, reading data from a fourth point at a predetermined distance from the second point in an opposite direction to a direction of the third point from the predetermined position of the burst cutting area.

The method may further comprise processing the data read from the fourth point to determine whether the data read from the fourth point corresponds to the burst cutting area data; and if the data read from the fourth point does not correspond to the burst cutting area data, reading data from a fifth point at a predetermined distance from the third point in an opposite direction to a direction of the fourth point from the predetermined position of the burst cutting area.

The method may further comprise if the data read from the fourth point corresponds to the burst cutting area data, reading data from a sixth point at a predetermined distance from the fourth point in an identical direction to a direction of the fourth point from the predetermined position of the burst cutting area.

The method may further comprise if the data read from the third point corresponds to the burst cutting area data, reading data from the fifth point at a predetermined distance from the third point in an identical direction to the direction of the third point from the predetermined position of the burst cutting area.

The method may further comprise determining whether the data read from the three adjacent points corresponds to the BCA data; and if all of the data read from the three adjacent points corresponds to the burst cutting area data, determining the central point of the three consecutive point as the final position of the burst cutting area and storing the information as to the final position of the burst cutting area as the information to seek the burst cutting area in the memory of the optical reproducing apparatus.

If all of the data read from the three adjacent points does not correspond to the burst cutting area data, the reading of data may be repeated.

The final position of the burst cutting area may be determined depending on a type of the optical disc.

Storing the information as to the final position of the burst cutting area may be performed in an adjustment process of the optical reproducing apparatus.

If the optical reproducing apparatus fails to seek the burst cutting area after the optical disc is loaded, storing the information as to the final position of the burst cutting area may be performed.

The memory may be an electrically erasable programmable read-only memory.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic block diagram of an optical reproducing apparatus according to an embodiment of the present invention;

FIG. 2 is a schematic block diagram of a BCA seek deviation adjustment apparatus used in a method for adjusting a deviation occurring on seeking a BCA in an optical according to an embodiment of the present invention;

FIG. 3 is a flowchart of a BCA seek learning process adopted in a method for adjusting a deviation occurring on seeking a BCA in an optical disc using an optical reproducing apparatus according to an embodiment of the present invention; and

FIG. 4 is a flowchart of a method for adjusting a deviation occurring on seeking a BCA in an optical disc using an optical reproducing apparatus according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Certain embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

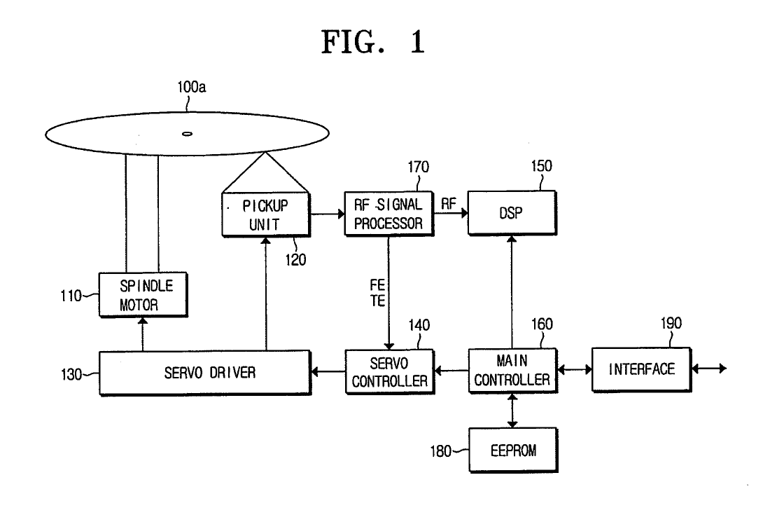

FIG. 1 is a schematic block diagram of an optical reproducing apparatus according to an embodiment of the present invention. Referring to FIG. 1, the optical reproducing apparatus comprises an optical disc 100a, a spindle motor 110, a pickup unit 120, a servo driver 130, a servo controller 140, a digital signal processor (DSP) 150, a main controller 160, a radio frequency (RF) signal processor 170, an electrically erasable programmable read-only memory (EEPROM) 180, and an interface 190.

The optical reproducing apparatus reproduces data from the optical disc 100a and may be a compact disc player (CDP), a digital versatile player (DVDP), or the like. The optical disc 110a is an optical recording medium including a data recorded area and a data unrecorded area and may be CD±Recordable (CD±R), DVD±R, CD±Rewritable (CD±RW), DVD±RW, DVD-RAM, or the like.

The spindle motor 110 is a DC motor spinning the optical disc 100a that is loaded at a predetermined speed at a drive voltage supplied from the servo driver 130.

The pickup unit 120 irradiates a laser beam onto the optical disc 100a and then receives light reflected from the optical disc 100a to read data from the optical disc 100a. For this purpose, the pickup unit 120 comprises a laser diode as a light source, an objective lens, a focusing actuator, a tracking actuator, a photodiode as a photodetector, and the like.

The servo driver 130 is controlled by the servo controller 140 to drive the spindle motor 110 and the pickup unit 120. For this purpose, the servo driver 130 comprises a motor driver (not shown) driving the spindle motor 110, a focusing driver (not shown) driving the focusing actuator, a tracking driver driving the tracking actuator, and the like.

The servo controller 140 controls a focusing servo and a tracking servo and outputs a control signal for driving the focusing actuator, for example, a focusing correction signal for the focusing servo, to the focusing driver in response to a focus error (FE) signal generated by the RF signal processor 170, and a control signal for driving the tracking actuator, for example, a tracking correction signal for the tracking servo, to the tracking driver in response to a tracking error (TE) signal generated by the RF signal processor 170.

The DSP 150 receives an RF signal from the RF signal processor 170, modulates the RF signal, and performs error correction on the modulated RF signal to generate reproduction data.

The main controller 160 controls the overall operation of the optical reproducing apparatus. For example, the main controller 160 controls the servo controller 140, the DSP 150, and the RF signal processor 170 to read the data from the optical disc 110a so as to convert the read data into a reproducible signal.

The RF signal processor 170 generates an RF sum signal (hereinafter referred to as an RF signal), the FE signal, the TE signal, and the like using an electric signal output form the pickup unit 120. The RF signal processor 170 provides the FE and TE signals to the servo controller 140 to control the focusing and tracking servos of the pickup unit 120.

The EEPROM 180 stores data to seek a BCA in the optical disc 100a using the optical reproducing apparatus, a program for adjusting a deviation occurring on seeking the BCA, and the like.

The interface 190 interfaces the main controller 160 with a BCA seek deviation adjustment apparatus performing an adjustment process of the optical reproducing apparatus or an external apparatus such as a personal computer (PC) to transmit data for performing the adjustment process of the optical reproducing apparatus to or receives the data from the external apparatus.

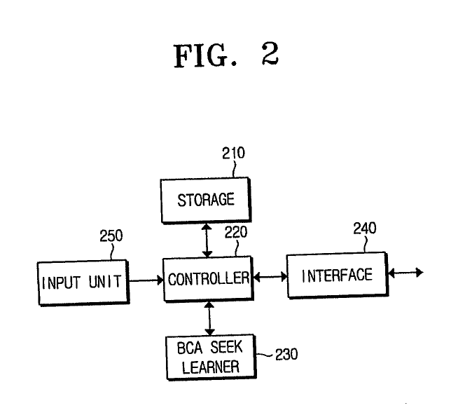

FIG. 2 is a schematic block diagram of a BCA seek deviation adjustment apparatus used in a method for adjusting a deviation occurring on seeking a BCA in an optical disc according to an embodiment of the present invention. Referring to FIG. 2, the BCA seek deviation adjustment apparatus comprises a storage 210, a controller 220, a BCA seek learner 230, an interface 240, and an input unit 250.

The storage 210 stores information to seek a BCA according to the type of an optical disc and various programs for operating the BCA seek deviation adjustment apparatus.

The input unit 250 receives a manipulation command and transmits the manipulation command to the controller 220 or receives data to be stored in the storage 210. A user may input a command to perform an adjustment process for adjusting a deviation occurring on seeking the BCA via the input unit 250.

When the controller 220 receives the command to the perform the adjustment process via the input unit 250, the controller 220 communicates with the optical reproducing apparatus using the information and the various programs stored in the storage 210 to the adjustment process for adjusting the deviation on seeking the BCA.

The BCA seek learner 230 performs various computations for adjusting the deviation on seeking the BCA using the information and the various programs received from the controller 220 and transmits the resultant values of the computations to the controller 220.

Accordingly, the controller 220 communicates with the optical reproducing apparatus via the interface 240 using the resultant values transmitted from the BCA seek learner 230 and performs the adjustment process of the optical reproducing apparatus for adjusting the deviation on seeking the BCA.

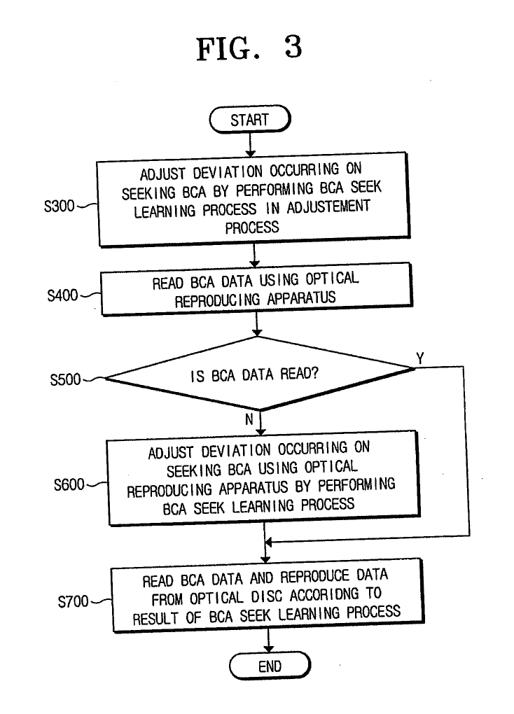

FIG. 3 is a flowchart of a BCA seek learning process adopted in a method for adjusting a deviation occurring on seeking a BCA in an optical disc using an optical reproducing apparatus according to an embodiment of the present invention.

At operation S300, a BCA seek learning process for adjusting a deviation occurring on seeking a BCA is performed using BCA seek information predetermined using a BCA seek deviation adjustment apparatus according to the type of an optical disc in an adjustment process of an optical reproducing apparatus. The BCA seek learning process will be described in detail later.

When the optical disc is loaded, at operation S400, the optical reproducing apparatus, which has performed the BCA seek learning process for adjusting the deviation on seeking the BCA, seeks the BCA in the optical disc to read data according to the BCA seek information determined in the BCA seek learning process.

At operation S500, the optical reproducing apparatus determines whether BCA data is read from the sought BCA, according to the BCA seek information.

When the optical reproducing apparatus seeks the BAC according to the BCA seek information but the BAC data is not read from the BCA, a deviation occurs on seeking the BAC due to an instrumental variation occurring in the optical reproducing apparatus or various external factors. Thus, at operation S600, the optical reproducing apparatus repeats the BCA seek learning process using a program for adjusting the deviation on seeking the BCA so as to adjust the deviation on seeking the BCA.

At operation S700, the optical reproducing apparatus seeks the BCA according to the BCA seek information and reads the BCA data from the BCA to reproduce data from the optical disc.

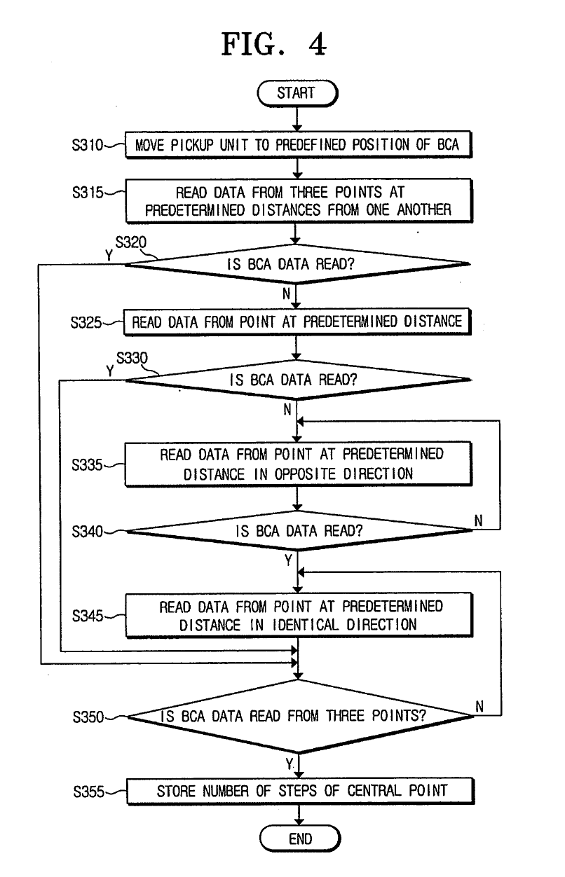

FIG. 4 is a flowchart of a method for adjusting a deviation occurring on seeking a BCA in an optical disc according to an embodiment of the present invention.

The BCA seek learning process will be described with reference to FIG. 4. The BCA seek deviation adjustment apparatus communicates with the optical reproducing apparatus in the adjustment process of the optical reproducing apparatus to perform the BCA seek learning process for adjusting the deviation on seeking the BCA.

When the command to perform the adjustment process for adjusting the deviation on seeking the BCA is input via the input unit 250 of the BCA seek deviation adjustment apparatus, the controller 220 communicates with the optical reproducing apparatus to perform the adjustment process according to the BCA seek information and the various programs stored in the storage 210.

When the controller 220 receives a command to adjust the deviation on seeking the BCA via the input unit 250 of the BCA seek deviation adjustment apparatus in the adjustment process, at operation S310, the controller 220 transmits data via the interface 240 to the optical reproducing apparatus according to the BCA seek information stored in the storage 210 and controls the optical reproducing apparatus to drive the servo driver 130 by a preset number of steps so as to move the pickup unit 120 to a predetermined position of the BCA.

The position of the BCA on the optical disc is determined by the number of steps of a transfer motor transferring the pickup unit 120 from a predetermined reference position. For example, when the predetermined reference position is determined as a starting position of a track in which data is recorded and the servo driver 130 is driven to drive the transfer motor from the predetermined reference position by the preset number of steps, turning off the tracking actuator, the pickup unit 120 is moved to the predetermined position of the BCA. The predetermined position of the BCA is a default value that is determined using data experimentally obtained according to the model of the optical reproducing apparatus before the optical reproducing apparatus is manufactured.

The pickup unit 120 of the optical reproducing apparatus transmits an electric signal read from the predetermined position of the BCA to which the pickup unit 120 has been moved to the RF signal processor 170 so as to generate an RF signal. The DSP 150 processes the RF signal. The main controller 160 interprets data processed by the DSP 150 to determine whether data read and processed by the pickup unit 120 corresponds to the BCA data.

The main controller 160 controls the servo controller 140 according to data received via the interface 190 to move the pickup unit 120 from the predetermined position of the BCA to a first point at a predetermined distance from the predetermined position of the BCA and reads data from the optical disc at the first point via the pickup unit 120. The main controller 160 also controls the servo controller 140 to move the pickup unit 120 to a second point at a predetermined distance from the predetermined position of the BCA in an opposite direction to a direction along which the pickup unit 120 moves to the first point and reads data from the optical disc at the second point via the pickup unit 120.

In other words, at operation S315, the BCA seek deviation adjustment apparatus allows the pickup unit 120 of the optical reproducing apparatus to read data from the optical disc at three points including the predetermined position of the BCA as the central point. The BCA seek learner 230 of the BCA seek deviation adjustment apparatus determines distances among the three points depending on the BCA seek information. For example, the distances among the three points may be a distance corresponding to 1% of a distance from the predetermined reference position to the predetermined position of the BCA. Thus, the transfer motor may be transferred by the number of steps corresponding to the determined distances to move the pickup unit 120 to each of the three points.

At operation S320, the main controller 160 interprets the data that has been read from the three point, including the predetermined position of the BCA, at predetermined distances and processed by the RF signal processor 170 and the DSP 150 to determine whether the BCA data is read from the three points and transmits the determination result to the BCA seek deviation adjustment apparatus.

If the main controller 160 determines that the BCA data is not read from any one of the three points, the controller 220 of the BCA seek deviation adjustment apparatus transmits data commanding to read data from a third point at a predetermined distance from one (here, it is supposed as the first point) of the first and second points on the optical disc to the optical reproducing apparatus using data transmitted from the BCA seek learner 230 in order to adjust the deviation on seeking the BCA. Thus, at operation S325, the main controller 160 controls the servo controller 140 to drive the servo driver 130 so as to move the pickup unit 120 to a new point and read data from the new point.

At operation S330, the main controller 160 determines whether the data read from the third point at a predetermined distance from the first point of the three points including the predetermined position of the BCA as the central point corresponds to the BCA data and transmits the determination result to the BCA seek deviation adjustment apparatus.

If the main controller 160 determines that the BCA data is not read from the third point, the main controller 160 moves the pickup unit 120 to a fourth point at a predetermined distance from the second point in an opposite direction to a direction along which the pickup unit 120 moves to the third point and reads data from the fourth point (S335).

If the data is read from the fourth point, at operation S340, the main controller 160 determines whether the data read from the fourth point corresponds to the BCA data and transmits the determination result to the BCA seek deviation adjustment apparatus.

If the main controller 160 determines that the data read from the fourth point corresponds to the BCA data, at operation S345, the main controller 160 moves the pickup unit 120 to a sixth point at a predetermined distance from the fourth point in an identical direction to a direction along which the pickup unit 120 moves to the fourth point according to a command from the BCA seek deviation adjustment apparatus, reads data from the sixth point, and determines whether the data read from the sixth point corresponds to the BCA data.

At operation S350, the main controller 160 determines whether the BCA data is read from all of three adjacent points of the first through sixth points from which the data has been read.

If the main controller 160 determines that the BCA data is read from all of the three adjacent points, at operation S355, the central point of the three adjacent points is determined as a new position of the BCA in which the deviation occurring on seeking the BCA has been adjusted and the number of steps of the transfer motor corresponding to the position of the central point is stored as adjusted information to seek the BCA in the EEPROM 180.

If the main controller 160 determines that the BCA data is not read from all of the three adjacent points, the main controller 160 returns to operation S345 to repeat operation S345 until the BCA data is read from all of the three adjacent points.

If the main controller 160 determines that the BCA data is not read from the third point and thus moves the pickup unit 120 to the fourth point at the predetermined distance from the second point in the opposite direction to the direction along which the pickup unit 120 moves to the third point and reads the data from the fourth point at operation S335. However, if the main controller 160 determines that the BCA data is not read from the fourth point, the main controller 160 returns to operation S335 and moves the pickup unit 120 to a fifth point at a predetermined distance from the third point in an opposite direction to a direction along which the pickup unit 120 moves to the fourth point and reads data from the fifth point until the BCA data is read from the fifth point.

The BCA seek learning process of the optical reproducing apparatus performed by the BCA seek deviation adjustment apparatus in the adjustment process has been described. As described above, when a BCA deviation is adjusted in an adjustment process of an optical reproducing apparatus, a BCA deviation occurring due to an instrumental position deviation of each of mass produced optical reproducing apparatuses and a motor deviation not due to experimental data of each of the mass produced optical reproducing apparatuses can be adjusted so as to rapidly seek a BCA during reproduction with respect to an optical disc.

If a BCA seek deviation of an optical reproducing apparatus is adjusted in an adjustment process as described above, BCA data may not be read according to the BCA seek information stored in the EEPROM 180, that is, a deviation may occur on seeking a BCA due to an instrumental variation of the optical reproducing apparatus or various external factors. In this case, a BCA seek learning process as performed in the adjustment process is repeated using a program for adjusting the deviation on seeking the BCA to adjust the deviation on seeking the BCA. The BCA seek learning process is the same as that performed in the adjustment process. However, the optical reproducing apparatus performs the BCA seek learning process using the BCA seek information and the program stored in the EEPROM 180 under the control of the main controller 160.

If the optical reproducing apparatus fails to seek the BCA due to the deviation, the optical reproducing apparatus can rapidly adjust the deviation and seek the BCA so as to rapidly reproduce data from an optical disc.

As described above, in a method for adjusting a deviation occurring on seeking a BCA in an optical disc according to an embodiment of the present invention, the BCA seek deviation can be adjusted by performing a BCA seek learning process in an adjustment process of an optical reproducing apparatus. Also, information as to the adjusted BCA seek deviation can be stored in the optical reproducing apparatus to rapidly seek the BCA from the optical disc regardless of an instrumental position deviation of the optical reproducing apparatus or a motor deviation.

In a case where the BCA seek deviation occurs in the optical reproducing apparatus due to various external factors, the BCA seek deviation can be adjusted according to the information as to the adjusted BCA seek deviation and a program for adjusting the BCA seek deviation, the information and the program being stored in the optical reproducing apparatus, so as to rapidly seek the BCA.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method for adjusting a deviation occurring on seeking a burst cutting area (BCA) on an optical disc for a recording and/or reproducing apparatus, comprising:
reading data from a predetermined position of the BCA when an optical disc is loaded into the recording and/or reproducing apparatus;
reading data from the predetermined position of the BCA and first and second points at predetermined distances from left and right sides of the predetermined position of the BCA;
processing the read data to determine whether the read data corresponds to BCA data; and
determining the predetermined position of the BCA as a final position of the BCA in which a deviation has been adjusted if the data read from all of the predetermined position of the BCA and the first and second points corresponds to the BCA data.

2. The method of claim 1, further comprising:
storing information as to the final position of the BCA as information to seek the BCA in a memory.

3. The method of claim 1, further comprising:
reading data from a third point at a predetermined distance from the first point in an opposite direction to a direction of the second point from the predetermined position of the BCA if the data read from all of the predetermined position of the BCA and the first and second points does not correspond to the BCA.

4. The method of claim 3, further comprising:
processing the data read from the third point to determine whether the data read from the third point corresponds to the BCA data; and
reading data from a fourth point at a predetermined distance from the second point in an opposite direction to a direction of the third point from the predetermined position of the BCA if the data read from the third point does not correspond to the BCA data.

5. The method of claim 4, further comprising:
processing the data read from the fourth point to determine whether the data read from the fourth point corresponds to the BCA data; and
reading data from a fifth point at a predetermined distance from the third point in an opposite direction to a direction of the fourth point from the predetermined position of the BCA if the data read from the fourth point does not correspond to the BCA data

6. The method of claim 5, further comprising:
reading data from a sixth point at a predetermined distance from the fourth point in an identical direction to a direction of the fourth point from the predetermined position of the BCA if the data read from the fourth point corresponds to the BCA data.

7. The method of claim 4, further comprising:
reading data from the fifth point at a predetermined distance from the third point in an identical direction to the direction of the third point from the predetermined position of the BCA if the data read from the third point corresponds to the BCA data.

8. The method of claim 3, further comprising:
determining whether the data read from the three adjacent points corresponds to the BCA data; and
if all of the data read from the three adjacent points corresponds to the BCA data, determining the central point of the three consecutive point as the final position of the BCA and storing the information as to the final position of the BCA as the information to seek the BCA in the memory.

9. The method of claim 4, further comprising:
determining whether the data read from the three adjacent points corresponds to the BCA data; and
if all of the data read from the three adjacent points corresponds to the BCA data, determining the central point of the three consecutive point as the final position of the BCA and storing the information as to the final position of the BCA as the information to seek the BCA in the memory.

10. The method of claim 5, further comprising:
determining whether the data read from the three adjacent points corresponds to the BCA data; and
if all of the data read from the three adjacent points corresponds to the BCA data, determining the central point of the three consecutive point as the final position of the BCA and storing the information as to the final position of the BCA as the information to seek the BCA in the memory.

11. The method of claim 6, further comprising:
determining whether the data read from the three adjacent points corresponds to the BCA data; and
if all of the data read from the three adjacent points corresponds to the BCA data, determining the central point of the three consecutive point as the final position of the BCA and storing the information as to the final position of the BCA as the information to seek the BCA in the memory.

12. The method of claim 6, further comprising:
determining whether the data read from the three adjacent points corresponds to the BCA data; and
if all of the data read from the three adjacent points corresponds to the BCA data, determining the central point of the three consecutive point as the final position of the BCA and storing the information as to the final position of the BCA as the information to seek the BCA in the memory.

13. The method of claim 8, wherein, if all of the data read from the three adjacent points does not correspond to the BCA data, the reading of data is repeated.

14. The method of claim 9, wherein, if all of the data read from the three adjacent points does not correspond to the BCA data, the reading of data is repeated.

15. The method of claim 10, wherein, if all of the data read from the three adjacent points does not correspond to the BCA data, the reading of data is repeated.

16. The method of claim 11, wherein, if all of the data read from the three adjacent points does not correspond to the BCA data, the reading of data is repeated.

17. The method of claim 12, wherein, if all of the data read from the three adjacent points does not correspond to the BCA data, the reading of data is repeated.

18. The method of claim 1, wherein the final position of the BCA is determined depending on a type of the optical disc.

19. The method of claim 1, wherein the operation of determining and storing the information as to the final position of the BCA is performed in an adjustment process of the recording and/or reproducing apparatus.

20. The method of claim 1, wherein if the recording and/or reproducing apparatus fails to seek the BCA after the optical disc is loaded, determining and storing the information as to the final position of the BCA is performed.

21. The method of claim 1, wherein the memory is an electrically erasable programmable read-only memory.

22. A recording and/or reproducing apparatus for adjusting a deviation occurring on to seek a burst cutting area (BCA) of a disc, comprising:
an interface;
a controller communicating with the recording and/or reproducing apparatus using information and various programs stored in the storage;
a BCA seeker performing various computations to adjust the deviation occurring on to seek the BCA on the disc; and
a storage storing the information to seek the BCA based upon a BCA seek information.
